(19) United States
(12) Patent Application Publication
(10) Pub. No.: US 2025/0382448 A1
(43) Pub. Date: Dec. 18, 2025

(54) ACRYLIC RUBBER, RUBBER COMPOSITION AND CROSSLINKED PRODUCT OF SAME

(71) Applicant: Denka Company Limited, Tokyo (JP)

(72) Inventors: Kazunori MASUKO, Chuo Tokyo (JP); Toshiaki MIYAUCHI, Chuo Tokyo (JP)

(21) Appl. No.: 18/878,083

(22) PCT Filed: Jun. 12, 2023
(86) PCT No.: PCT/JP2023/021757

§ 371 Date: Dec. 23, 2024

(30) Foreign Application Priority Data
Jun. 30, 2022 (JP) 2022-106174

(51) Int. Cl. C08L 13/00

(52) U.S. Cl. CPC C08L 13/00; C08L 2203/18; C08L 2312/00

(57) ABSTRACT

An acrylic rubber containing an alkyl acrylate, an alkyl methacrylate, and an alkoxyalkyl acrylate, as monomer units, wherein a mass ratio of a content of the alkyl acrylate to a content of the alkoxyalkyl acrylate is 2 or more and 9 or less.

### TECHNICAL FIELD

The present disclosure relates to an acrylic rubber, a rubber composition, and a crosslinked product thereof.

### BACKGROUND ART

Crosslinked products of acrylic rubbers are used as materials for hoses and sealing parts in automobile engine compartments due to their excellent properties such as heat resistance, oil resistance, and mechanical properties. For example, Patent Literature 1 discloses an acrylic rubber contains 45 to 89.5% by weight of a structural unit (A) derived from an alkyl acrylate having an alkyl group having 1 to 8 carbon atoms and/or an alkoxyalkyl acrylate having an alkoxyalkyl group having 2 to 8 carbon atoms, 10 to 50% by weight of a structural unit (B) derived from an alkyl methacrylate having an alkyl group having 3 to 16 carbon atoms, and 0.5 to 5% by weight of a structural unit (C) derived from a crosslinking monomer having a carboxy group, which is for a crosslinked product with excellent heat resistance, even under long-term high-temperature conditions, having a small change rate in elongation and hardness.

### CITATION LIST

### Patent Literature

Patent Literature 1: International Publication No. 2018/101146

### SUMMARY OF INVENTION

### Technical Problem

An aspect of the present invention aims to provide an acrylic rubber that can yield a crosslinked product with excellent cold resistance and compression set.

### Solution to Problem

The present inventors have found that an acrylic rubber containing an alkyl acrylate, an alkyl methacrylate, and an alkoxyalkyl acrylate, as monomer units, with a mass ratio of the content of the alkyl acrylate to the content of the alkoxyalkyl acrylate within a specific range, results in a crosslinked product with excellent cold resistance and compression set.

The present invention includes the following aspects:
(1) An acrylic rubber containing an alkyl acrylate, an alkyl methacrylate, and an alkoxyalkyl acrylate, as monomer units, wherein a mass ratio of a content of the alkyl acrylate to a content of the alkoxyalkyl acrylate is 2 or more and 9 or less.
(2) The acrylic rubber according to (1), wherein the alkyl methacrylate contains an alkyl methacrylate having an alkyl group having 3 or more carbon atoms.
(3) The acrylic rubber according to (2), wherein a content of the alkyl methacrylate having an alkyl group having 3 or more carbon atoms is 5% by mass or more and 15% by mass or less based on a total amount of the monomer units in the acrylic rubber.
(4) The acrylic rubber according to any one of (1) to (3), wherein a content of the alkyl acrylate is 50% by mass or more and 85% by mass or less based on a total amount of the monomer units in the acrylic rubber.
(5) The acrylic rubber according to any one of (1) to (4), wherein a content of the alkoxyalkyl acrylate is 10% by mass or more and 25% by mass or less based on the total amount of the monomer units in the acrylic rubber.
(6) The acrylic rubber according to any one of (1) to (5), wherein the alkyl acrylate contains an alkyl acrylate having an alkyl group having 3 or less carbon atoms and an alkyl acrylate having an alkyl group having 4 or more carbon atoms, and a mass ratio of the content of the alkyl acrylate having an alkyl group having 4 or more carbon atoms to a content of the alkyl acrylate having an alkyl group having 3 or less carbon atoms is 0.5 or more and 9 or less.
(7) The acrylic rubber according to any one of (1) to (6), further containing a crosslinking monomer as the monomer units.
(8) A rubber composition containing the acrylic rubber according to any one of (1) to (7), and a crosslinking agent.
(9) The rubber composition according to (8), being used for a seal or a hose.
(10) A crosslinked product of the rubber composition according to (8) or (9).
(11) A seal or hose containing the crosslinked product according to (10).

### Advantageous Effects of Invention

According to one aspect of the present invention, an acrylic rubber that can yield a crosslinked product with excellent cold resistance and compression set can be provided.

### DESCRIPTION OF EMBODIMENTS

Hereinafter, embodiments of the present invention will be described in detail, but the present invention is not limited to these embodiments.

An embodiment of the present invention is an acrylic rubber containing an alkyl acrylate, an alkyl methacrylate, and an alkoxyalkyl acrylate, as monomer units.

The alkyl acrylate is represented by the following formula (1):

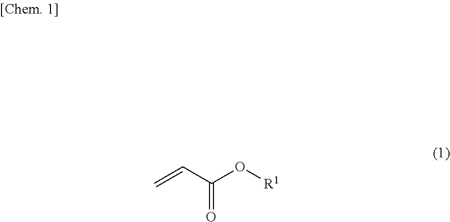

wherein R¹ represents an alkyl group.

The alkyl group (R¹) in the alkyl acrylate may be linear or branched. The number of carbon atoms in the alkyl group (R¹) in the alkyl acrylate may be 1 or more and may be 16 or less. Specific examples of the alkyl acrylate include methyl acrylate, ethyl acrylate, n-propyl acrylate, isopropyl acrylate, n-butyl acrylate, isobutyl acrylate, n-pentyl acrylate, isoamyl acrylate, n-hexyl acrylate, 2-methylpentyl acrylate, n-octyl acrylate, 2-ethylhexyl acrylate, lauryl acrylate, hexadecyl acrylate, 1-adamantyl acrylate, and cyclohexyl acrylate. These alkyl acrylates may be used singly or in combination of two or more.

The content of the alkyl acrylate may be 40% by mass or more, 50% by mass or more, or 60% by mass or more, and may be 90% by mass or less, 85% by mass or less, or 80% by mass or less, based on the total amount of the monomer units in the acrylic rubber.

From the viewpoint of further improving the oil resistance of the crosslinked product of the acrylic rubber, the alkyl acrylate preferably contains an alkyl acrylate having an alkyl group having 3 or less carbon atoms (first alkyl acrylate) and an alkyl acrylate having an alkyl group having 4 or more carbon atoms (second alkyl acrylate).

The number of carbon atoms in the alkyl group of the first alkyl acrylate may be 1 or more and 2 or less, and may be 2. The first alkyl acrylate is preferably ethyl acrylate. The number of carbon atoms in the alkyl group of the second alkyl acrylate may be 8 or less, 6 or less, or 5 or less, and may be 4. The second alkyl acrylate is preferably n-butyl acrylate.

The content of the first alkyl acrylate may be 5% by mass or more, 10% by mass or more, 20% by mass or more, or 30% by mass or more, and may be 70% by mass or less, 60% by mass or less, 50% by mass or less, or 40% by mass or less, based on the total amount of the monomer units in the acrylic rubber.

The content of the second alkyl acrylate may be 20% by mass or more, 30% by mass or more, or 40% by mass or more, and may be 70% by mass or less, 60% by mass or less, or 50% by mass or less, based on the total amount of the monomer units in the acrylic rubber.

The mass ratio of the content of the second alkyl acrylate to the content of the first alkyl acrylate (second alkyl acrylate/first alkyl acrylate) is preferably 0.5 or more, more preferably 1 or more, from the viewpoint of further improving the cold resistance of the crosslinked product of the acrylic rubber, and preferably 9 or less, 8 or less, 7 or less, 6 or less, 5 or less, or 4 or less, from the viewpoint of improving the oil resistance of the crosslinked product of the acrylic rubber.

The alkyl methacrylate is represented by the following formula (2):

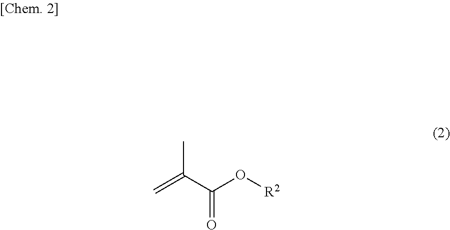

wherein R² represents an alkyl group.

The alkyl group (R²) in the alkyl methacrylate may be linear or branched. The number of carbon atoms in the alkyl group (R²) in the alkyl methacrylate may be 1 or more and may be 4 or less, preferably 2 or more or 3 or more, and may be 3. Specific examples of the alkyl methacrylate include methyl methacrylate, ethyl methacrylate, n-propyl methacrylate, isopropyl methacrylate, n-butyl methacrylate, and isobutyl methacrylate. These alkyl methacrylates may be used singly or in combination of two or more. From the viewpoint of improving the heat resistance of the acrylic rubber, the alkyl methacrylate is preferably n-butyl methacrylate.

The content of the alkyl methacrylate (preferably, an alkyl methacrylate having an alkyl group having 3 or more carbon atoms) may be preferably 5% by mass or more, 7% by mass or more, or 10% by mass or more, from the viewpoint of improving the hydrolysis resistance of the crosslinked product of the acrylic rubber, and may be preferably 30% by mass or less, 20% by mass or less, 15% by mass or less, or 13% by mass or less, from the viewpoint of further improving the oil resistance and cold resistance of the crosslinked product of the acrylic rubber.

The alkoxyalkyl acrylate is represented by the following formula (3):

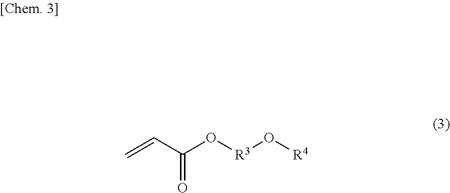

wherein R³ represents an alkylene group, and R⁴ represents an alkyl group.

The alkylene group (R³) and the alkyl group (R⁴) in the alkoxyalkyl acrylate may be linear or branched. The number of carbon atoms in the alkylene group (R³) in the alkoxyalkyl acrylate may be 1 or more or 2 or more, and may be 4 or less or 3 or less. The number of carbon atoms in the alkyl group (R⁴) in the alkoxyalkyl acrylate may be 1 or more, and may be 4 or less, 3 or less, or 2 or less.

Specific examples of the alkoxyalkyl acrylate include 2-methoxyethyl acrylate, 2-ethoxyethyl acrylate, 2-(n-propoxy)ethyl acrylate, 2-(n-butoxy)ethyl acrylate, 3-methoxypropyl acrylate, 3-ethoxypropyl acrylate, 2-(n-propoxy)propyl acrylate, and 2-(n-butoxy)propyl acrylate. These alkoxyalkyl acrylates may be used singly or in combination of two or more.

The content of the alkoxyalkyl acrylate may be 5% by mass or more, 10% by mass or more, or 12% by mass or more, and may be 30% by mass or less, 25% by mass or less, or 20% by mass or less, based on the total amount of the monomer units in the acrylic rubber.

In the acrylic rubber, the mass ratio of the content of the alkyl acrylate to the content of the alkoxyalkyl acrylate (alkyl acrylate/alkoxyalkyl acrylate) is 2 or more and 9 or less. Thereby, a crosslinked product of the acrylic rubber with excellent cold resistance can be obtained. The mass ratio may be 2.5 or more, 3 or more, 3.5 or more, 4 or more, or 4.5 or more, and may be 6 or less, 5.5 or less, or 5 or less.

The acrylic rubber may further contain a crosslinking monomer as the monomer units. The crosslinking monomer is a monomer that can be copolymerized with the alkyl acrylate, alkyl methacrylate, and alkoxyalkyl acrylate, and has a crosslinking group that forms a crosslinking site (also called a crosslinking point). The crosslinking monomer has a polymerizable carbon-carbon double bond, for example, an acryloyl group, a methacryloyl group, an allyl group, a methallyl group, a vinyl group, or an alkenylene group. Examples of the crosslinking group include a carboxyl group, an epoxy group, and an active chlorine group. The crosslinking monomer may have one or more of these functional groups.

Examples of the crosslinking monomer having a carboxyl group as the crosslinking group include acrylic acid, methacrylic acid, crotonic acid, 2-pentenoic acid, maleic acid, fumaric acid, itaconic acid, and monoalkyl maleate.

Examples of the crosslinking monomer having an epoxy group as the crosslinking group include glycidyl acrylate, glycidyl methacrylate, allyl glycidyl ether, and methallyl glycidyl ether.

Examples of the crosslinking monomer having an active chlorine group as the crosslinking group include 2-chloroethyl vinyl ether, 2-chloroethyl acrylate, vinylbenzyl chloride, vinyl chloroacetate, and allyl chloroacetate.

The content of the crosslinking monomer may be 1% by mass or more, 2% by mass or more, or 3% by mass or more, and may be 10% by mass or less, 8% by mass or less, or 6% by mass or less, based on the total amount of the monomer units in the acrylic rubber.

The acrylic rubber may contain an additional monomer copolymerizable with the above-described monomers as the monomer units. Examples of the additional monomer include ethylene, an alkoxy methacrylate, an alkyl vinyl ketone, a vinyl ether, an allyl ether, a vinyl aromatic compound, a vinyl nitrile, a dialkyl maleate, a dialkyl fumarate, a dialkyl itaconate, a dialkyl citraconate, a dialkyl mesaconate, a dialkyl 2-pentene diacid, and a dialkyl acetylenedicarboxylate.

The acrylic rubber can be obtained by copolymerizing the above-described monomers by a known polymerization method such as emulsion polymerization, suspension polymerization, solution polymerization, or bulk polymerization.

Another embodiment of the present invention is a rubber composition containing the above-described acrylic rubber. The rubber composition may further contain a crosslinking agent. The rubber composition may further contain a crosslinking accelerator. In this case, the rubber composition is kneaded at a temperature equal to or lower than the crosslinking temperature and then heated at a predetermined crosslinking temperature to obtain a crosslinked product. Another embodiment of the present invention is a crosslinked product of the above-described rubber composition.

The heating conditions for crosslinking can be appropriately set depending on the blending of the rubber composition or the type of the crosslinking agent. The heating temperature may be 100° C. or higher and may be 200° C. or lower. The heating time may be 1 hour or longer and may be 10 hours or shorter. As a heating method, methods used in crosslinking of rubber such as hot press heating, steam heating, and oven heating can be used.

Apparatuses for kneading, molding, and crosslinking the rubber composition, and apparatuses for kneading and molding the crosslinked product of the rubber composition, can be apparatuses generally used for rubber compositions. As the kneading apparatus, a roll, a kneader, a Banbury mixer, an internal mixer, and a twin-screw extruder can be used.

The crosslinking agent is not particularly limited as long as it is generally used in crosslinking of the acrylic rubber. For example, in a case where the acrylic rubber contains a crosslinking monomer having a carboxyl group as the monomer units, the crosslinking agent is preferably a polyamine compound and a carbonate of a polyamine compound, and more preferably a polyamine compound having 4 to 30 carbon atoms and a carbonate thereof.

Specific examples of the polyamine compound include aromatic polyamine compounds such as 4,4′-bis(4-aminophenoxy)biphenyl, 4,4′-diaminodiphenyl sulfide, 1,3-bis(4-aminophenoxy)-2,2-dimethylpropane, 1,3-bis(4-aminophenoxy)benzene, 1,4-bis(4-aminophenoxy)benzene, 1,4-bis(4-aminophenoxy)pentane, 2,2-bis[4-(4-aminophenoxy)phenyl]propane, 2,2-bis[4-(4-aminophenoxy)phenyl]sulfone, 4,4′-diaminodiphenylsulfone, bis(4-3-aminophenoxy)phenylsulfone, 2,2-bis[4-(4-aminophenoxy)phenyl]hexafluoropropane, 3,4′-diaminodiphenyl ether, 4,4′-diaminodiphenyl ether, 4,4′-diaminobenzanilide, and bis[4-(4-aminophenoxy)phenyl]sulfone; and aliphatic polyamine compounds such as hexamethylenediamine, hexamethylenediamine carbamate, N,N′-dicinnamylidene-1,6-hexanediamine, diethylenetriamine, triethylenetetramine, and tetraethylenepentamine.

The content of the crosslinking agent in the rubber composition may be 0.1 parts by mass or more, 0.2 parts by mass or more, or 0.3 parts by mass or more, and may be 5 parts by mass or less, 4 parts by mass or less, or 3 parts by mass or less, with respect to 100 parts by mass of the acrylic rubber.

The crosslinking accelerator is not particularly limited, but in a case where the crosslinking agent is a polyamine compound or a carbonate thereof, examples of the crosslinking accelerator include an aliphatic secondary monoamine compound, an aliphatic tertiary monoamine compound, a guanidine compound, an imidazole compound, a quaternary onium salt, a tertiary phosphine compound, an alkali metal salt of weak acid, and a diazabicycloalkene compound. The crosslinking accelerator can be used singly or in combination of two or more.

Examples of the aliphatic secondary monoamine compound include dimethylamine, diethylamine, di-n-propylamine, diallylamine, diisopropylamine, di-n-butylamine, di-t-butylamine, di-sec-butylamine, dihexylamine, diheptylamine, dioctylamine, dinonylamine, didecylamine, diundecylamine, didodecylamine, ditridecylamine, ditetradecylamine, dipentadecylamine, dicetylamine, di-2-ethylhexylamine, dioctadecylamine, di-cis-9-octadecenylamine, and dinonadecylamine.

Examples of the aliphatic tertiary monoamine compound include trimethylamine, triethylamine, tri-n-propylamine, triallylamine, triisopropylamine, tri-n-butylamine, tri-t-butylamine, tri-sec-butylamine, tripentylamine, trihexylamine, triheptylamine, trioctylamine, trinonylamine, tridecylamine, triundecylamine, tridodecylamine, tridecylamine, tritetradecylamine, tripentadecylamine, tricetylamine, tri-2-ethylhexylamine, trioctadecylamine, tri-cis-9-octadecenylamine, trinonadecylamine, N,N-dimethyldecylamine, N,N-dimethyldodecylamine, N,N-dimethyltetradecylamine, N,N-dimethylcetylamine, N,N-dimethyloctadecylamine, N,N-dimethylbehenylamine, N-methyldidecylamine, N-methyldidodecylamine, N-methylditetradecylamine, N-methyldicetylamine, N-methyldioctadecylamine, N-methyldibehenylamine, and dimethylcyclohexylamine.

Examples of the guanidine compound include 1,3-di-o-tolylguanidine and 1,3-diphenylguanidine.

Examples of the imidazole compound include 2-methylimidazole and 2-phenylimidazole.

The quaternary onium salt is not particularly limited, and examples thereof include ammonium salts such as tetra-n-butylammonium chloride, trimethylphenylammonium chloride, trimethylstearylammonium chloride, trimethyllaurylammonium chloride, trimethylcetylammonium chloride, dimethyldistearylammonium chloride, tributylbenzylammonium chloride, tetra-n-butylammonium bromide, methyltriphenylammonium bromide, ethyltriphenylammonium bromide, trimethylphenylammonium bromide, trimethylbenzylammonium bromide, trimethylstearylammonium bromide, and tetrabutylammonium thiocyanate, and phosphonium salts such as tetra-n-butylphosphonium chloride, tetra-n-butylphosphonium bromide, methyltriphenylphosphonium bromide, ethyltriphenylphosphonium bromide, butyltriphenylphosphonium bromide, hexyltriphenylphosphonium bromide, benzyltriphenylphosphonium bromide, tetraphenylphosphonium chloride, tetraphenylphosphonium bromide, 4-butoxybenzyltriphenylphosphonium bromide, allyltributylphosphonium chloride, 2-propynyltriphenylphosphonium bromide, and methoxypropyltributylphosphonium chloride.

Examples of the tertiary phosphine compound include triphenylphosphine and tri-p-tolylphosphine.

Examples of the alkali metal salt of weak acid include inorganic weak acid salts such as phosphates and carbonates of sodium and potassium, and organic weak acid salts such as stearates and laurates of sodium and potassium.

Examples of the diazabicycloalkene compound include 1,8-diazabicyclo[5.4.0]undecene-7 (DBU), 1,5-diazabicyclo[4.3.0]nonene-5 (DBN), and 1,4-diazabicyclo[2.2.2]octane (DABCO). These diazabicycloalkene compounds may form salts, for example, with hydrochloric acid, sulfuric acid, carboxylic acid, sulfonic acid, phenol, and the like. Examples of the carboxylic acid include octylic acid, oleic acid, formic acid, orthophthalic acid, and adipic acid. Examples of the sulfonic acid include benzenesulfonic acid, toluenesulfonic acid, dodecylbenzenesulfonic acid, and naphthalene sulfonic acid.

The content of the crosslinking accelerator in the rubber composition may be 0.1 parts by mass or more, 0.2 parts by mass or more, or 0.3 parts by mass or more, and may be 5 parts by mass or less, 4 parts by mass or less, or 3 parts by mass or less, with respect to 100 parts by mass of the acrylic rubber.

The rubber composition may further contain an additional additive. Examples of the additional additive include a filler (reinforcing agent), a plasticizer, a lubricant, an anti-aging agent, a stabilizer, and a silane coupling agent.

The total content of the additional additives in the rubber composition may be 0.1 parts by mass or more or 0.2 parts by mass or more, and may be 90 parts by mass or less or 80 parts by mass or less, with respect to 100 parts by mass of the acrylic rubber.

The above-described rubber composition is suitably used as a rubber composition for a seal (also referred to as a sealing member) or a hose (also referred to as a hose member). The rubber composition can also be used as a rubber composition for a vibration-proof rubber (also referred to as a vibration-proof rubber member). The crosslinked product of the above-described rubber composition is suitably used as a seal or hose. That is, another embodiment of the present invention is a seal or hose containing the above-described crosslinked product. The crosslinked product can also be used as a vibration-proof rubber. That is, another embodiment of the present invention is a vibration-proof rubber containing the above-described crosslinked product. Examples of the hose (hose member) include rubber hoses. Examples of the seal (sealing member) include gaskets and packings. These members may consist of the crosslinked product of the rubber composition, and may contain this crosslinked product and an additional part.

Specific examples of the hose (hose member) include transmission oil cooler hoses, engine oil cooler hoses, air duct hoses, turbo intercooler hoses, hot air hoses, radiator hoses, power steering hoses, fuel-line hoses, and drain-line hoses of automobiles, construction machines, hydraulic equipment, and the like. The hose member may have reinforcing filaments or wires in an intermediate layer or an outermost layer of the hose.

Specific examples of the seal (sealing member) include engine head cover gaskets, oil pan gaskets, oil seals, lip seal packings, O-rings, transmission seal gaskets, crank shafts, cam shaft seal gaskets, valve stems, power steering seals, belt cover seals, constant-velocity-joint boot materials, and rack-and-pinion boot materials.

Specific examples of the vibration-proof rubber (vibration-proof rubber member) include damper pulleys, center support cushions, and suspension bushings.

### EXAMPLES

Hereinafter, the present invention will be more specifically described based on examples, but the present invention is not limited by these examples.

### (Production of Acrylic Rubber)

In a pressure-resistant reaction container having an internal volume of 40 liters, a 4% by mass aqueous solution of partially saponified polyvinyl alcohol and sodium formaldehyde sulfoxylate were charged, and the whole was thoroughly mixed with a stirrer in advance, thereby preparing a homogeneous suspension. After replacing the air in the upper part of the reaction container with nitrogen, the reaction container was maintained at 45° C., and the monomers shown in Table 1 and an aqueous solution of 0.125% by mass of t-butyl hydroperoxide were separately injected under pressure to start polymerization. The amount of partially saponified polyvinyl alcohol added was 4.88 parts by mass with respect to 100 parts by mass of the total amount of the alkyl acrylate, alkyl methacrylate, and alkoxyalkyl acrylate. The temperature in the reaction container was maintained at 45° C., and the reaction was performed until the polymerization conversion ratio reached 95%. To the resulting polymerization liquid, 20 kg of an aqueous solution of 0.3% by mass of sodium borate was added to solidify the polymer, and the polymer was dehydrated and dried to obtain an acrylic rubber. The Mooney viscosity ML (1+4) 100° C. of the obtained acrylic rubber was measured according to the method specified in JIS K6300. The results are shown in Table 1.

### (Production of Rubber Composition and Crosslinked Product)

100 parts by mass of each of the obtained acrylic rubbers, 55 parts by mass of carbon black (N550 (SEAST SO manufactured by TOKAI CARBON CO., LTD.)) as a filler, 1 part by mass of liquid paraffin (HICOOL K-230 manufactured by Kaneda Co., Ltd.), 1 part by mass of stearic acid (manufactured by NOF CORPORATION), 0.3 parts by mass of stearylamine (FARMIN 80S manufactured by Kao Corporation), 0.5 parts by mass of a phosphate ester (MOLDWIZ INT-21G manufactured by Tomoe Engineering Co., Ltd.) as lubricants, 1 part by mass of 4,4′-bis(α,α-dimethylbenzyl)diphenylamine (NAUGARD 445 manufactured by Addivant USA LLC) as an anti-aging agent, 0.6 parts by mass of hexamethylenediamine carbamate (Diak #1 manufactured by DuPont) as a crosslinking agent, and 0.5 parts by mass of a synthetic mixture of active amine and retarder (XLA-60 manufactured by LANXESS) as a crosslinking accelerator were kneaded using an 8-inch open roll to obtain a rubber composition.

Each of the obtained rubber compositions was molded into a thickness of 2 mm and subjected to a heating treatment with a hot press at 170° C. for 20 minutes to obtain a primary crosslinked product (crosslinked product precursor). Subsequently, the primary crosslinked product was subjected to a heating treatment with hot air (geer oven) at 170° C. for 4 hours to obtain a crosslinked product of the rubber composition.

The obtained crosslinked products were evaluated as follows. The results are shown in Table 1.

### (Evaluation of Cold Resistance)

T100 of the crosslinked products was measured according to JIS K6261:2006. T100 means the temperature at which the crosslinked product exhibits the value of 100 times as the specific modulus at 23° C. The lower the T100, the better the cold resistance.

### (Evaluation of Compression Set)

The compression set (%) of the crosslinked products was measured according to JIS K6262:2013 by performing a thermal treatment at 150° C. for 72 hours at a compression rate of 25%. The smaller the compression set, the better.

TABLE 1

| | | Example | | | | | | | Comparative Example | | |
|---|---|---|---|---|---|---|---|---|---|---|---|
| | | 1 | 2 | 3 | 4 | 5 | 6 | 7 | 1 | 2 | 3 |
| Monomer | Ethyl acrylate (EA) | 25 | 48 | 35 | 23 | 15 | 7 | 54 | 8 | 65 | 62 |
| composition | n-Butyl acrylate (BA) | 40 | 27 | 40 | 52 | 60 | 68 | 27 | 67 | 25 | 20 |
| (parts by | n-Butyl methacrylate | 10 | 10 | 10 | 10 | 10 | 10 | 10 | — | 10 | 10 |
| mass) | 2-Methoxyethyl acrylate | 25 | 15 | 15 | 15 | 15 | 15 | 9 | 25 | — | 8 |
| | (MEA) | | | | | | | | | | |
| | Monobutyl maleate | 5 | 5 | 5 | 5 | 5 | 5 | 5 | 5 | 5 | 5 |
| Mass ratio of (EA + BA)/MEA | | 2.60 | 5.00 | 5.00 | 5.00 | 5.00 | 5.00 | 9.00 | 3.00 | — | 10.25 |
| Mass ratio of BA/EA | | 1.60 | 0.56 | 1.14 | 2.26 | 4.00 | 9.71 | 0.50 | 8.38 | 0.38 | 0.32 |
| Mooney viscosity of acrylic rubber | | 34 | 43 | 38 | 33 | 32 | 30 | 43 | 29 | 48 | 46 |
| Properties of | Cold resistance T100 | −35 | −28 | −32 | −35 | −38 | −40 | −26 | −43 | −23 | −24 |
| crosslinked | (° C.) | | | | | | | | | | |
| product | Compression set (%) | 18 | 16 | 14 | 17 | 15 | 17 | 16 | 24 | 12 | 15 |

In Examples 1 to 7, the crosslinked products of the acrylic rubber with excellent cold resistance and compression set were obtained. On the other hand, the crosslinked product of the acrylic rubber in Comparative Example 1 was excellent in terms of the cold resistance but inferior in terms of the compression set. In addition, the crosslinked products of the acrylic rubber in Comparative Examples 2 and 3 were excellent in terms of the compression set but inferior in terms of the cold resistance.

### (Evaluation of Oil Resistance)

Regarding Examples 1 to 7, the oil resistance of the crosslinked products was also evaluated as follows.

Evaluation samples were prepared according to JIS K6250:2019, and the evaluation samples were immersed in IRM903 oil at 150° C. for 72 hours according to JIS K6258:2016. The volume change rate ΔV (%) of the evaluation samples before and after immersion was measured. The results are shown in Table 2. The smaller the volume change rate, the better the oil resistance.

TABLE 2

Example

| | 1 | 2 | 3 | 4 | 5 | 6 | 7 |
|---|---|---|---|---|---|---|---|
| Oil resistance | 29 | 23 | 30 | 41 | 49 | 58 | 23 |
| ΔV (%) | | | | | | | |

1. An acrylic rubber comprising an alkyl acrylate, an alkyl methacrylate, and an alkoxyalkyl acrylate, as monomer units,
wherein a mass ratio of a content of the alkyl acrylate to a content of the alkoxyalkyl acrylate is 2 or more and 9 or less.

2. The acrylic rubber according to claim 1, wherein the alkyl methacrylate comprises an alkyl methacrylate having an alkyl group having 3 or more carbon atoms.

3. The acrylic rubber according to claim 2, wherein a content of the alkyl methacrylate having an alkyl group having 3 or more carbon atoms is 5% by mass or more and 15% by mass or less based on a total amount of the monomer units in the acrylic rubber.

4. The acrylic rubber according to claim 1, wherein a content of the alkyl acrylate is 50% by mass or more and 85% by mass or less based on a total amount of the monomer units in the acrylic rubber.

5. The acrylic rubber according to claim 1, wherein a content of the alkoxyalkyl acrylate is 10% by mass or more and 25% by mass or less based on a total amount of the monomer units in the acrylic rubber.

6. The acrylic rubber according to claim 1, wherein the alkyl acrylate comprises an alkyl acrylate having an alkyl group having 3 or less carbon atoms and an alkyl acrylate having an alkyl group having 4 or more carbon atoms, and
a mass ratio of a content of the alkyl acrylate having an alkyl group having 4 or more carbon atoms to a content of the alkyl acrylate having an alkyl group having 3 or less carbon atoms is 0.5 or more and 9 or less.

7. The acrylic rubber according to claim 1, further comprising a crosslinking monomer as the monomer units.

8. A rubber composition comprising the acrylic rubber according to claim 1, and a crosslinking agent.

9. The rubber composition according to claim 8, being used for a seal or a hose.

10. A crosslinked product of the rubber composition according to claim 8.

11. A seal or hose comprising the crosslinked product according to claim 10.
